(19) United States
(12) Patent Application Publication
(10) Pub. No.: US 2026/0328580 A1
(43) Pub. Date: Oct. 22, 2026

(54) Pathfinding method and device, pathfinding graph neural network training method and device, medium, and computer program product

(71) Applicant: SHANGHAI LILITH TECHNOLOGY CORPORATION, Shanghai (CN)

(72) Inventors: Huanhua Liao, Shanghai (CN); Xin Xiong, Shanghai (CN); Junfeng Li, Shanghai (CN); Zhikai Li, Shanghai (CN); Haonan Zhao, Shanghai (CN)

(21) Appl. No.: 19/105,060

(22) PCT Filed: Mar. 15, 2023
(86) PCT No.: PCT/CN2023/081569

§ 371 Date: Feb. 20, 2025

(51) Int. Cl. G01C 21/00; G06N 3/042; G06N 3/09

(52) U.S. Cl. CPC G01C 21/3804; G06N 3/042; G06N 3/09

(57) ABSTRACT

The present invention relates to a pathfinding method that includes acquiring a target map in a navigation grid format, and information of a starting grid and a target grid in the target map; converting the target map into target graph data, wherein a first label is added to nodes corresponding to the starting grid and the target grid in the target graph data; inputting the target graph data into a pre-trained pathfinding graph neural network, wherein the pathfinding graph neural network adds the first label to some nodes of the target graph data and a second label to the remaining nodes; and determining path grids in the target map, wherein the path grids are navigation grids of the target map which correspond to the nodes to which the first label is added.

### TECHNICAL FIELD

The invention relates to the field of computer technology, and in particular to a pathfinding method and a device, a pathfinding graph neural network training method and a device, a medium, and a computer program product.

### BACKGROUND

Automatic pathfinding is a process that abstracts map features into data structures in a computer, and then uses an appropriate algorithm to find a feasible path. This process is divided into two steps: 1) modeling: abstracting the map into a data structure; 2) pathfinding: using an algorithm to find the path.
1) The modeling methods include:
   a) Dividing the map into many equal-sized small grids and using a two-dimensional array to represent each grid. Grids blocked by obstacles are marked as 0, indicating they are impassable, while walkable areas are marked as 1. This method is easy to implement and dynamically modify, but it involves large computation and memory usage, and movement around obstacles can appear unnatural.
   b) Marking walkable points on the map, i.e., path points, and connecting two passable points to form a path, so all movement paths are limited to the segments between connected lines. This method is easy to implement and takes up little memory, but the path is singular, and if a walkable point overlaps with an obstacle, it can cause movement into the obstacle.
   c) Converting the map into a polygonal mesh, i.e., a navigation grid, and establishing adjacency relationships between the polygons. For 3D environments, this method can calculate the intersections of the path points and the edges of the polygons of the path after pathfinding has found path points. The height change between two adjacent polygons can then be used to determine the height changes at path points, allowing this method to adapt to 3D environments. It is the mainstream modeling method currently used for automatic pathfinding in games.
2) The pathfinding algorithms include:
   a) Breadth-first search algorithm: starting from the starting point, traversing adjacent points, then traversing the adjacent points of the adjacent points, continuing until the target point is found. This algorithm has a time complexity of O(n²) and is very inefficient.
   b) Dijkstra's algorithm: based on the breadth-first search algorithm, adding the path closest to the starting point to the path tree, and using a greedy algorithm to calculate and eventually obtain the optimal result. This algorithm can avoid longer routes or impassable areas, but before encountering an obstacle, its performance is the same as breadth-first search algorithm, meaning it is still inefficient.
   c) Greedy best-first search algorithm: similar to Dijkstra's algorithm, but compared to the Dijkstra's algorithm, which uses the method of traversing the points closest to the starting point first, the greedy best-first search algorithm uses the method of traversing the points closest to the target point first. This method reduces the number of adjacent points traversed before encountering an obstacle, but since it always selects the node closest to the target point, the path found may not be optimal.
   d) A* algorithm: combines Dijkstra's algorithm and greedy best-first search algorithm, using the smaller of the distance between the current point and the starting point and the estimated distance between the current point and the target point to find the path. Therefore, it also combines the advantages of the Dijkstra's algorithm and the greedy best-first search algorithm. Therefore, this algorithm is adopted by current mainstream games.

In the above algorithms, breadth-first search algorithm is completely blind, while the other algorithms use the distance between the current point and the starting point or the target point as heuristics to avoid traversing too many adjacent points. However, these algorithms cannot obtain prior map information every time they find a path, and even if multiple pathfinding tasks are carried out on the same map, each one is independent, with no experience carried over to the next. Furthermore, in 3D environments, if the starting and target points are at different heights (e.g., on different floors), the heuristics used in pathfinding algorithms become ineffective, causing the algorithms to degrade into breadth-first search algorithm.

### SUMMARY

The purpose of this invention is to provide a pathfinding method and a device, a pathfinding graph neural network training method and a device, a medium, and a computer program product, to address issues in existing pathfinding technologies, such as low efficiency, non-optimal pathfinding results, the inability to obtain prior map information, and the lack of experience carried over after multiple pathfinding tasks on the same map.

A first embodiment of this invention discloses a pathfinding method for an electronic device, comprising:
acquiring a target map in a navigation grid format, and information of a starting grid and a target grid in the target map;
converting the target map into target graph data, wherein a first label is added to nodes corresponding to the starting grid and the target grid in the target graph data;
inputting the target graph data into a pre-trained pathfinding graph neural network, wherein the pathfinding graph neural network adds the first labels to some nodes of the target graph data and second labels to the remaining nodes; and
determining path grids in the target map, wherein the path grids are navigation grids of the target map which correspond to the nodes to which the first labels are added.

Optionally, the method of claim 1, the pathfinding graph neural network is pre-trained through the following steps:
acquiring first sample graph data of a sample map and information of multiple sets of sample path grids in the sample map; adding first labels to the first sample nodes corresponding to the multiple sets of sample path grids in the first sample graph data, and adding second labels to the remaining first sample nodes, thereby obtaining second sample graph data;
training the graph neural network to be trained using the second sample graph data, so that the graph neural network to be trained learns the feature representation of the second sample graph data, and the influence probability distribution of the influence of the feature representation on the first labels or second labels;
M-step: using the influence probability distribution, adding the first labels or second labels to the first sample nodes in the first sample graph data, thereby obtaining third sample graph data, using part of the second sample nodes in the second sample graph data and part of the third sample nodes in the third sample graph data, training the graph neural network to be trained to learn the joint probability distribution of the nodes labeled with the first labels or second labels and the nodes not labeled with the first labels or second labels;
E-step: using the joint probability distribution, adding the first labels or second labels to the first sample nodes in the first sample graph data, thereby obtaining fourth sample graph data, using the fourth sample nodes in the fourth sample graph data and the second sample nodes in the second sample graph data, training the graph neural network to be trained to learn the influence probability distribution;
repeating the M-step and E-step until the prediction accuracy of the influence probability distribution and the joint probability distribution on the first labels and second labels of the second sample nodes in the second sample graph data exceeds a predetermined threshold, thereby obtaining the pathfinding graph neural network.

Optionally, acquiring first sample graph data of a sample map and information of multiple sets of sample path grids in the sample map, comprising:
acquiring a sample map in a navigation grid format and information of multiple sets of sample starting grids and sample target grids in the sample map;
determining multiple sets of sample path grids using the A* algorithm based on the multiple sets of sample starting grids and sample target grids.

Optionally, the pathfinding method further including:
the pathfinding graph neural network determining the feature representation of the target graph data, and the joint probability distribution of the nodes labeled with the first labels or second labels and the nodes not labeled with the first labels or second labels;
using GPU parallel computing to add the first labels or second labels to the nodes in the target graph data that have not been labeled, based on the feature representation of the target graph data and the joint probability distribution.

Optionally, wherein the joint probability distribution is conditioned on the feature representation of the graph data.

A second embodiment of this invention discloses a method for training a pathfinding graph neural network for an electronic device, comprising:
acquiring first sample graph data of a sample map and information of multiple sets of sample path grids in the sample map; adding first labels to the first sample nodes corresponding to the multiple sets of sample path grids in the first sample graph data, and adding second labels to the remaining first sample nodes, thereby obtaining second sample graph data;
training the graph neural network to be trained using the second sample graph data, so that the graph neural network to be trained learns the feature representation of the second sample graph data, and the influence probability distribution of the influence of the feature representation on the first labels or second labels;
M-step: using the influence probability distribution, adding the first labels or second labels to the first sample nodes in the first sample graph data, thereby obtaining third sample graph data, using part of the second sample nodes in the second sample graph data and part of the third sample nodes in the third sample graph data, training the graph neural network to be trained to learn the joint probability distribution of the nodes labeled with the first labels or second labels and the nodes not labeled with the first labels or second labels;
E-step: using the joint probability distribution, adding the first labels or second labels to the first sample nodes in the first sample graph data, thereby obtaining fourth sample graph data, using the fourth sample nodes in the fourth sample graph data and the second sample nodes in the second sample graph data, training the graph neural network to be trained to learn the influence probability distribution;
repeating the M-step and E-step until the prediction accuracy of the influence probability distribution and the joint probability distribution on the first labels and second labels of the second sample nodes in the second sample graph data exceeds a predetermined threshold, thereby obtaining the pathfinding graph neural network.

Optionally, acquiring first sample graph data of a sample map and information of multiple sets of sample path grids in the sample map, comprising:
acquiring a sample map in a navigation grid format and information of multiple sets of sample starting grids and sample target grids in the sample map;
determining multiple sets of sample path grids using the A* algorithm based on the multiple sets of sample starting grids and sample target grids.

Optionally, wherein the joint probability distribution is conditioned on the feature representation of the graph data.

A third embodiment of this invention discloses an electronic device, which includes a memory storing computer-executable instructions and a processor; when the instructions are executed by the processor, the electronic device implements the pathfinding method according to the first embodiment of this invention or the method for training a pathfinding graph neural network according to the second embodiment of this invention.

A fourth embodiment of this invention discloses a computer storage medium, on which instructions are stored; when the instructions are executed on a computer, the computer executes the pathfinding method according to the first embodiment of this invention or the method for training a pathfinding graph neural network according to the second embodiment of this invention.

A fifth embodiment of this invention discloses a computer program product including computer-executable instructions executed by a processor to implement the pathfinding method according to the first embodiment of this invention or the method for training a pathfinding graph neural network according to the second embodiment of this invention.

Compared with the prior art, the embodiments of this invention have the following main differences and effects:

In this invention, the problem of existing graph neural networks being unable to handle starting and target points as inputs is overcome, making graph neural networks applicable to pathfinding; the representation and learning capabilities of graph neural networks are used to remember the map structure, allowing map experience to be reused in each pathfinding task, speeding up pathfinding.

In this invention, by adding first labels to part of the path grids and using the graph neural network to label the remaining path grids, the method supports pathfinding from a starting point through several specific points to a target point, providing greater flexibility compared to the prior art.

In this invention, the map is represented in advance, prior knowledge of the map is obtained before pathfinding, and the joint probability distribution allows for the labeling of all nodes in one GPU parallel computation, making the pathfinding process faster than existing iterative algorithms.

In this invention, since the joint probability distribution allows for the GPU parallel computation of all node labels in one step, the method can still quickly perform pathfinding even in 3D navigation scenarios.

### DESCRIPTION OF DRAWINGS

FIG. 1 shows a flow chart of a pathfinding method according to an embodiment of the application.

FIG. 2A shows a schematic diagram of an original map according to an embodiment of the application.

FIG. 2B shows a schematic diagram of a target map in a navigation grid format according to an embodiment of the application.

FIG. 3A shows a schematic diagram of a pathfinding graph neural network according to an embodiment of the application.

FIG. 3B shows a schematic diagram of a graph neural network to be trained according to an embodiment of the application.

FIG. 4 shows a flow chart of the training steps of a pathfinding graph neural network according to an embodiment of the application.

FIG. 5 shows a structural diagram of an electronic device according to an embodiment of the application.

### DETAILED DESCRIPTION

To make the objectives, technical solutions, and advantages of the present application clearer, the following further describes the embodiments of the present application in detail with reference to the accompanying drawings.

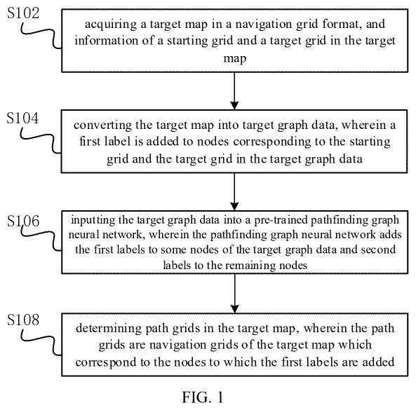

In view of the low efficiency of existing pathfinding technologies, the possibility of the pathfinding result not being the optimal path, the inability to acquire prior map information, and the lack of experience retained after multiple pathfinding processes on the same map, the embodiments of this application provide a pathfinding method that converts the map into graph data and uses a graph neural network for pathfinding. FIG. 1 shows a flowchart of this pathfinding method. As shown in FIG. 1, the method includes:

S102, acquiring a target map in a navigation grid format, and information of a starting grid and a target grid in the target map.

For example, the original map can undergo navigation grid modeling, which converts the original map into multiple polygon grids and establishes the adjacency relationships between these polygons to obtain the target map in a navigation grid format. The data structure of the target map is an array of objects, where each object is a polygon, and contains the list of vertices of the polygon and a connection list of adjacent polygons.

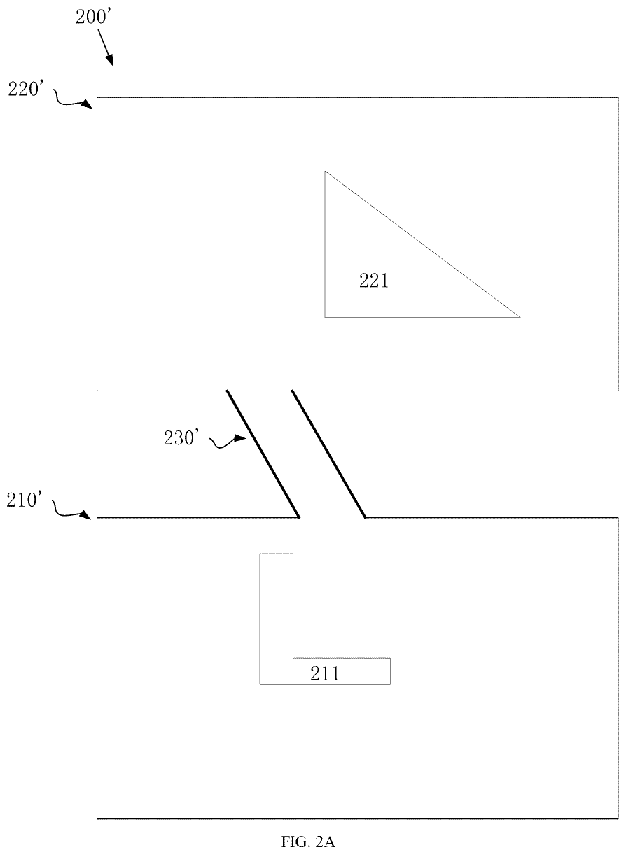

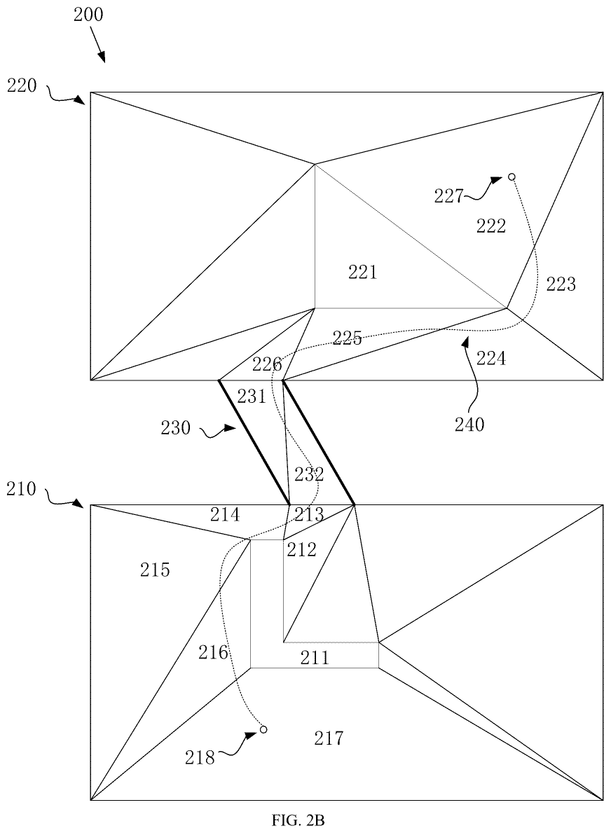

FIG. 2A shows an original map 200′, where the original map 200′ includes a first part 210′ and a second part 220′, with the first part 210′ and the second part 220′ connected by a connecting part 230′. For example, the original map 200′ can be a network map or a map in a video game, where the first part 210′ and the second part 220′ can be islands, and the connecting part 230′ can be a bridge. The first part 210′ contains obstacle 211, and the second part 220′ contains obstacle 221. By performing navigation grid modeling on the original map 200′, as shown in FIG. 2B, the original map 200′ is converted into target map 200, where the target map 200 includes multiple polygon grids, each grid being a region comprising multiple points. Exemplarily, the polygons in the figure are triangles and quadrilaterals.

As an example, the original map 200′ is a map in a video game, and the navigation grid modeling produces the target map 200 in a navigation grid format. At a certain point in time, a player-controlled character is located at point 218 (the starting point) in the first part 210. Point 218 is included in grid 217. The player issues a command, instructing the character to go to point 227 (the target point) in the second part 220. Point 227 is included in grid 222. In this scenario, the grid 217 where point 218 (the starting point) is located is determined as the starting grid, and the grid 222 where point 227 (the target point) is located is determined as the target grid.

S104, converting the target map into target graph data, wherein a first label is added to nodes corresponding to the starting grid and the target grid in the target graph data.

For example, in the scenario shown in FIG. 2B, in response to the player's command, it is necessary to find a path between the grid 217 and the grid 222 in the target map 200. Essentially, the target map 200 in the navigation grid format can be regarded as graph data and processed by using a graph neural network (GNN).

A graph is a data structure composed of a set of nodes (vertices) and a set of relationships between the nodes, that is, a set of edges: G=(V, E), where G represents the graph, V={v₁, v₂, . . . , v} is a finite, non-empty set of nodes, and E is a finite set of relationships between nodes, also known as the edge set. The edge between two nodes can either be directed or undirected. If directed, it is called a directed graph; otherwise, it is called an undirected graph. Since traditional deep learning cannot handle data in non-Euclidean spaces, the expansion of deep learning methods to graph data has garnered increasing attention in recent years. Inspired by convolutional networks, recurrent networks, and deep autoencoders, neural networks have been defined and designed to process graph data, that is graph neural networks (GNNs). GNNs can be classified into five categories: graph convolutional networks, graph attention networks, graph autoencoders, graph generative networks, and graph spatiotemporal networks. However, none of these five categories of GNNs can be directly used for pathfinding.

The graph data processed by GNNs can be represented by a feature matrix, an adjacency matrix, and a degree matrix, where the feature matrix represents the features of the nodes in the graph data, the adjacency matrix represents the connections between the nodes, and the degree matrix represents the degree of the nodes, which refers to the number of other nodes connected to the node.

In this application, the topology of the target map 200, modeled in a navigation grid format (object array), can be regarded as an undirected graph, where each grid is anode on this undirected graph, and the adjacency relationship between grids determines whether there is an edge between the nodes. Since graph data is mainly described by the feature matrix, adjacency matrix, and degree matrix of the nodes of the graph, converting the target map in a navigation grid format (object array) into a graph mainly involves converting the object array describing the navigation grid into the three matrices that describe the graph data. For target map 200, the object array describing the navigation grid is converted into:
1) Feature matrix X: Each row of the feature matrix X represents the features of a node in the graph data, corresponding to a grid before the conversion. The features of the node are defined as the vertex coordinates of its corresponding grid. For example, when a three-dimensional map is modeled using navigation grids of the same shape, if the modeled map has n grids, and each grid has m vertices, the dimension of the feature matrix X is n×3 m. After modeling, the three-dimensional target map 200 has 20 grids, and each grid is a triangle with 3 vertices, so the dimension of feature matrix X^{t} of the target graph data converted from the target map 200 is 20×9.
2) Adjacency matrix A: The adjacency matrix A represents whether there is an edge between the nodes. For a map with n grids after modeling, the adjacency matrix A is an n×n dimensional 0/1 matrix, where Aᵢⱼ=0 indicates that there is an edge between the i-th and j-th nodes, and Aᵢⱼ=1 indicates that there is no edge between the i-th and j-th nodes. A is a symmetric matrix, and Aᵢᵢ=1. The dimension of adjacency matrix A^{t} of the target graph data converted from the target map 200 is 20×20.
3) Degree matrix D: The degree matrix D represents the degree of each node. For a map with n grids after modeling, the degree matrix D is an n×n dimensional diagonal matrix defined as D=diag(d(v₁), . . . , d(vₙ)), where d(vᵢ)=Σ_{jϵN(i)} Aᵢⱼ, representing the number of edges connected to the i-th node. The dimension of degree matrix D^{t} of the target graph data converted from the target map 200 is 20×20.

Afterward, a first label is added to the nodes in the target graph data corresponding to the starting grid 217 and the target grid 222. In this application, the first label can be a number “1”.

S106, inputting the target graph data into a pre-trained pathfinding graph neural network, wherein the pathfinding graph neural network adds the first labels to some nodes of the target graph data and second labels to the remaining nodes;

The core of the pathfinding method according to the embodiments of this application lies in leveraging the learning capabilities and graph representational power of graph neural networks. Through learning the paths between different starting and target points on a map, the method “memorizes” the map, thereby gaining the ability to obtain prior map information before each pathfinding task. To facilitate the processing by the graph neural network, if a path already exists on a sample map in a navigation grid format from a starting point to a target point, first labels may be added to the grids that the path traverses, which means that these grids are marked as “roads,” and second labels may be added to the remaining grids, which means that these grids are marked as “non-roads”. These labeled sample maps are then used to train the pathfinding graph neural network. Subsequently, during pathfinding, the target graph data converted from the target map 200 is input into the pre-trained pathfinding graph neural network. The pathfinding graph neural network, based on the feature representations in the target graph data and the fact that the nodes corresponding to the starting grid 217 and the target grid 222 have been added with first labels (e.g., the number “1”), classifies other nodes in the graph data, wherein first labels (e.g., the number “1”) are added to some nodes and second labels (e.g., the number “0”) are added to the remaining nodes. In this way, the pathfinding problem is transformed into a node classification problem corresponding to the navigation grids.

S108, determining path grids in the target map, wherein the path grids are navigation grids of the target map which correspond to the nodes to which the first labels are added.

For example, the pre-trained pathfinding graph neural network may add first labels to the nodes corresponding to grid 216, grid 215, grid 214, grid 213, grid 232, grid 231, grid 226, grid 225, grid 224, and grid 223 in the target graph data, while adding second labels to the remaining nodes other than the nodes corresponding to the starting grid 217 and the target grid 222. The pathfinding process determines the path grids between the starting grid 217 and the target grid 222 in the target map 200, wherein the path grids are: navigation grids of the target map 200 corresponding to nodes to which the first labels are added, namely, the starting grid 217, the target grid 222, the grid 216, the grid 215, the grid 214, the grid 213, the grid 232, the grid 231, the grid 226, the grid 225, the grid 224, and the grid 223. Based on these path grids and the starting point 218 and the target point 227, according to the inflection point algorithm, the inflection points along the way from the starting point 218 to the target point 227 can be calculated, and they can be organized into an array to generate the final moving path and realize pathfinding. In this application, after adding first labels to the nodes corresponding to the starting grid and the target grid in the target graph data, the pathfinding graph neural network is used to classify and label other nodes in the target graph data, and the navigation grids corresponding to the nodes with the first labels added are the path grids. Therefore, the pathfinding method of the present invention also supports passing through specific points. Specifically, before using the pathfinding graph neural network for classification, in addition to the starting grid and the target grid, the specific passing grids where the specific points is located can also be determined; After adding first labels to the nodes corresponding to the starting grid, target grid, and specific passing grids in the target graph data, the target graph data is input into the pathfinding graph neural network. The other nodes in the target graph data are classified through the pathfinding graph neural network. Finally the path grids corresponding to the nodes that obtain the first labels in the target map will contain the specific passing grids, and a moving path from the starting point through the specific point to the target point is generated based on the path grids.

In this application, the use of the representational and learning capabilities of graph neural networks allows the map's structure to be memorized, so that the map's experience can be reused for subsequent pathfinding tasks, thus speeding up the pathfinding process. By adding first labels to the starting grid and target grid and using the graph neural network to label the remaining path grids, supporting pathfinding from a starting point through several specific points to a target point, providing greater flexibility compared to the prior art.

In this application, the representation ability of the graph neural network is used, that is, the graph neural network is used to encode the graph in an optimal way, so that the feature representation of each node in the graph can more accurately represent its geography position and function in a map. As shown in FIG. 2B, a significant feature of the target map 200 is that the first part 210 (island) and the second part 220 (island) are separated, and are connected by a connecting part 230 (bridge). In the case where the starting point and the target point are located in the separated first part 210 (island) and the second part 220 (island), respectively, pathfinding can only be completed via the connecting part 230 (bridge). Existing algorithms require significant time to traverse the map and search for the connecting part 230 (the bridge) during each pathfinding task. However, in this invention, after the graph has been encoded by the graph neural network, the grid corresponding to the connecting part 230 (the bridge) will be assigned a higher weight for being classified with the first label. In other words, during subsequent new pathfinding reasoning tasks, these grids are predetermined to be passable, making them more likely to be labeled as “road” (the number “1”). Therefore, prior knowledge of the map is obtained, and the pathfinding speed is improved.

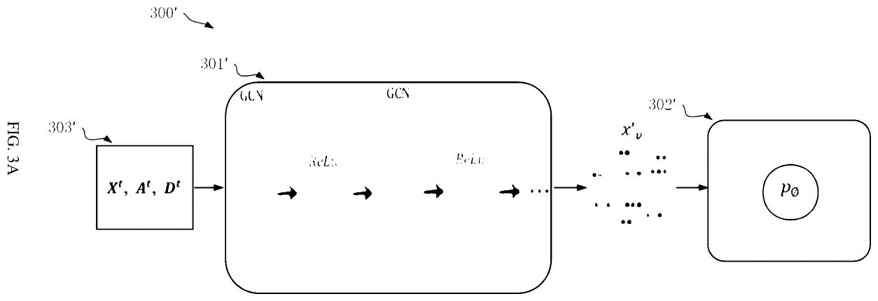

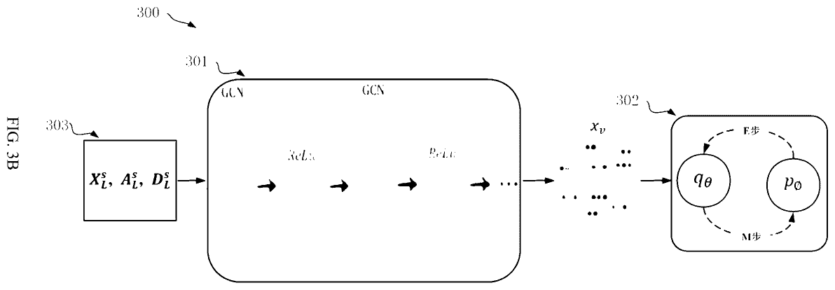

In some embodiments of this application, the pathfinding graph neural network is divided into a feature representation part and a probability distribution part, the feature representation part learns the representation of the graph; while the probability distribution part learns the joint probability distribution of the navigation grids with confirmed labels and those with unconfirmed labels of the path, so as to infer the grids passed by the entire path through the determined navigation grids. For example, as shown in FIG. 3A, the pathfinding graph neural network 300′ includes a feature representation part 301′ and a probability distribution part 302′. The feature representation part 301′ is a GCN (graph convolutional network). After adding first labels (e.g., the number “1”) to the nodes corresponding to the starting grid 217 and the target grid 222 in the target graph data of the target map 200, the target graph data 303′, including the feature matrix X^{t}, the adjacency matrix A^{t}, and the degree matrix D^{t}, is input into the feature representation part 301′. The feature representation part 301′ outputs the feature representation of the graph x′ᵥ=GCN_{φ}(D^{t}, A^{t}, X^{t}), the feature representationx′ᵥ is then input into the probability distribution part 302′. The probability distribution part 302′ has a pre-trained joint probability distribution pe, which represents the joint probability distribution of the nodes with the first labels or the second labels added and the nodes without the first labels or the second labels added. GPU parallel computation is used to classify each node in the graph data using po, adding first labels to some nodes, for example, the number “1” to indicate “road”, and adding second labels to the remaining nodes, for example, the number “0” to indicate “non-road”. The grids corresponding to all nodes with the first labels constitute the found path. In particular, for a certain map k, the feature representation part 301′ can be used to calculate the feature representation

$${x}_{v}^{′ k}$$

of the graph corresponding to map k in advance. Each subsequent time when finding a path on the map k, it is only necessary to add the first labels to the nodes corresponding to the starting grid and the target grid each time, and the trained pø can be used to add labels to the nodes in the graph without calculating the representation of the graph of map k each time.

In this invention, the map is represented in advance, prior knowledge of the map is obtained before pathfinding, and the joint probability distribution allows for the labeling of all nodes in one GPU parallel computation, making the pathfinding process faster than existing iterative algorithms. Since the joint probability distribution allows for the GPU parallel computation of all node labels in one step, it can still quickly perform pathfinding even in 3D navigation scenarios.

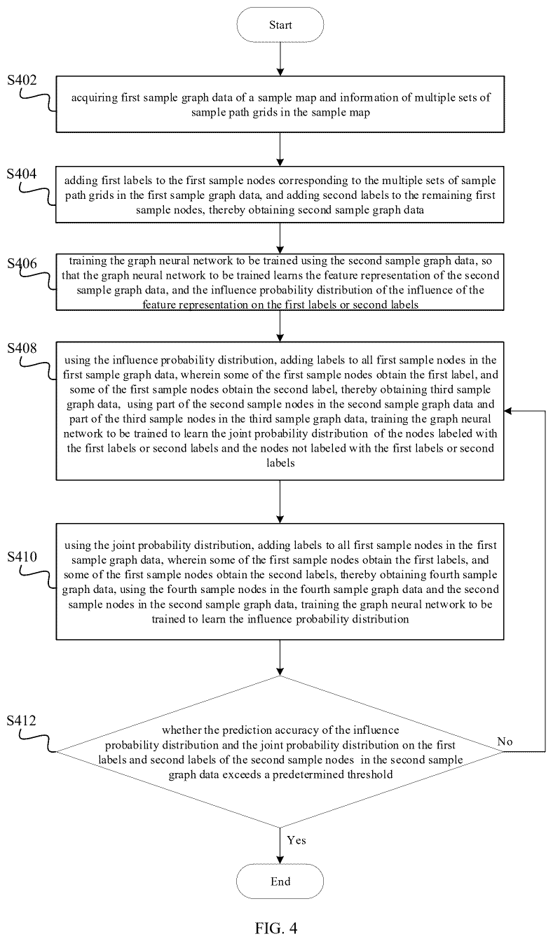

Embodiments of this application provide a method for training a pathfinding graph neural network. As shown in FIG. 4, the method includes the following steps:

S402, acquiring first sample graph data of a sample map and information of multiple sets of sample path grids in the sample map; For example, using the A* algorithm, based on multiple sets of sample starting grids and sample target grids in the sample map, perform multiple pathfinding operations on the sample map in a navigation grid format. The grids corresponding to the found paths are the sample path grids. It can be understood that the sample path grids include the sample starting grids and sample target grids.

S404, adding first labels to the first sample nodes corresponding to the multiple sets of sample path grids in the first sample graph data, and adding second labels to the remaining first sample nodes, thereby obtaining second sample graph data; For example, the first label can be a number “1”, and the second label can be a number “0”.

Specifically, none of the first sample nodes in the first sample graph data have any labels, and these nodes can be represented as y_{U}. Adding first labels to the first sample nodes corresponding to the multiple sets of sample path grids, and adding second labels to the remaining first sample nodes, thereby obtaining second sample graph data. All the nodes in the second sample graph data are referred to as second sample nodes and can be represented as y_{L}. Each second sample node y_{L} corresponds one-to-one with an original node y_{U}, but every second sample node y_{L} has been added either the first label or second label.

S406, training the graph neural network to be trained using the second sample graph data, so that the graph neural network to be trained learns the feature representation of the second sample graph data, and the influence probability distribution q_{θ} of the influence of the feature representation on the first labels or second labels;

For example, as shown in FIG. 3B, the graph neural network 300 to be trained includes a feature representation part 301 and a probability distribution part 302. The feature representation part 301 is a GCN (Graph Convolutional Network). The feature matrix

$${X}_{L}^{s} ,$$

adjacency matrix

$${A}_{L}^{s} ,$$

and degree matrix

$${D}_{L}^{s}$$

of the second sample graph data 303 are input into the feature representation part 301, which is trained based on a cross-entropy loss function. The feature representation part 301 learns and outputs the feature representation of the graph,

$${x}_{v} = G C {N}_{φ} ( {D}_{L}^{s} , {A}_{L}^{s} , {X}_{L}^{s} ) .$$

This feature representation xᵥ is then input into the probability distribution part 302, which is trained based on the cross-entropy loss function, wherein the training goal is for the probability distribution part 302 to learn the joint probability distribution p_{ø} of the nodes labeled with the first labels or second labels and the nodes without the first labels or second labels. However, since pø cannot be precisely inferred, the pseudo-likelihood function variational EM (Expectation-Maximization) algorithm used by GMNN (Graph Markov Neural Networks) is utilized to learn p_{ø}.

The pseudo-likelihood function variational EM algorithm combines the advantages of SRL (Statistic Relation Learning) and GNN, and iteratively learns the joint probability distribution p_{ø} and the influence probability distribution q_{θ} of the influence of the feature representation xᵥ on the first labels or the second labels through the E step and the M step. In this step, the probability distribution part 302 infers q_{θ}. In the subsequent M-step, q_{θ} is fixed while p_{ø} is updated, and in the E-step, p_{ø} is fixed while q_{θ} is updated, until the algorithm converges.

S408, ie, step M: using the influence probability distribution q_{θ}, adding labels to all first sample nodes in the first sample graph data, wherein some of the first sample nodes obtain the first labels, and some of the first sample nodes obtain the second labels, thereby obtaining third sample graph data, using part of the second sample nodes in the second sample graph data and part of the third sample nodes in the third sample graph data, training the graph neural network to be trained to learn the joint probability distribution p_{ø} of the nodes labeled with the first labels or second labels and the nodes not labeled with the first labels or second labels. For example, a batch of nodes are sampled from each of the second sample nodes y_{L} and the third sample nodes y_{U} to obtain ŷ_{V}=(y_{U} y_{L}), that is, some nodes in ŷ^{V} have sample labels of y_{L}, and some nodes have labels predicted by q_{θ}; training the probability distribution part 302 of the graph neural network 300 to be trained using ŷ_{V} and the first sample nodes y_{U}, so that the probability distribution part 302 learns the joint probability distribution p_{ø} of the nodes with the first labels or the second labels (i.e., the labels in ŷ_{V}) added and the nodes without the first labels or the second labels added.

S410, ie, step E: using the joint probability distribution p_{ø}, adding labels to all first sample nodes y_{U} in the first sample graph data, wherein some of the first sample nodes obtain the first labels, and some of the first sample nodes obtain the second labels, thereby obtaining fourth sample graph data, using the fourth sample nodes p_{ø}(y_{U}) in the fourth sample graph data and the second sample nodes y_{L} in the second sample graph data, training the graph neural network to be trained to learn the influence probability distribution q_{θ}.

In the steps above, the first sample graph data, second sample graph data, third sample graph data, and fourth sample graph data all have the same feature representation.

Specifically, since p_{ø} cannot be precisely inferred, the optimization goal needs to be transformed into the confidence lower bound of the log-likelihood function: log p_{φ}(y_{L}|x_{V})≥E_{qθ(y}_{_{L}}_{|x}_{_{V}}₎ [log p_{φ}(y_{L}, y_{U}|x_{V})−log q_{θ}(y_{U}|x_{V})] with the equation holding when q_{θ}(y_{U}|x_{V})=p_{φ}(y_{U}|y_{L}, x_{V}). Therefore, in the E step, p_{φ} is fixed and q_{θ} is updated to approximate the true posterior distribution, and in the M step, q_{θ} is fixed and p_{φ} is updated to maximize l(φ)=E_{qθ(y}_{_{U}}_{|x}_{_{V}}₎ [log p_{φ}(y_{L}, y_{U}|x_{V})].

S412: determine whether the prediction accuracy of the influence probability distribution q_{θ} and the joint probability distribution p_{ø} on the first labels and second labels of the second sample nodes y_{L} in the second sample graph data is higher than a predetermined threshold, if not, repeat S408 (M-step) and S410 (E-step), if so, end the training and obtain the pathfinding graph neural network. For example, repeat the M-step and E-step until the prediction accuracy by using p_{ø} and q_{θ} exceeds the predetermined threshold, meaning that the algorithm has converged. The prediction accuracy here refers to the degree to which the labels added to the first sample nodes by using p_{ø} or the labels added to the first sample nodes by using q_{θ} match the the labels of the second sample nodes corresponding to the first sample nodes. The predetermined threshold for prediction accuracy can be set according to actual needs.

According to some embodiments of this application, the pathfinding graph neural network is pre-trained using the steps of the above method for training a pathfinding graph neural network.

In existing graph neural networks, nodes are classified directly based on their adjacency relationships and node similarities, meaning that there is only one possible classification result for the nodes of a graph. However, in pathfinding, different classification results are required depending on different starting points and target points. Therefore, existing graph neural networks cannot be directly used for pathfinding. In this invention, by training the feature representation part to learn feature representations and training the probability distribution part to learn the joint probability distribution p_{ø} of node labels, the pathfinding graph neural network establishes a connection between the feature representation of each grid node and the label weights obtained by nodes, supporting pathfinding based on different starting points and target points each time.

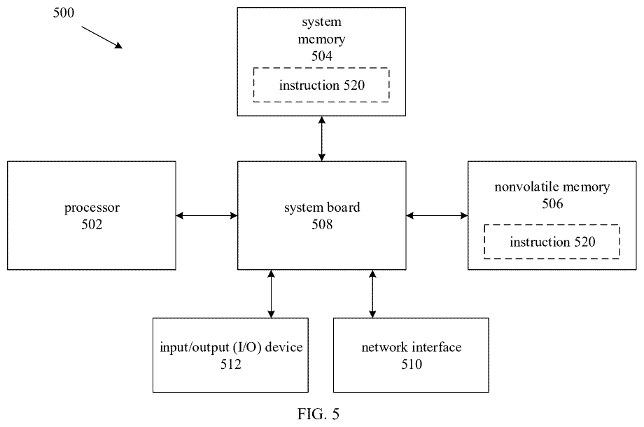

FIG. 5 shows a hardware structure block diagram of an electronic device implementing pathfinding according to an embodiment of the application.

As shown in FIG. 5, an electronic device 500 may include one or more processors 502, a system board 508 connected to at least one of the processors 502, a system memory 504 connected to the system board 508, a nonvolatile memory (NVM) 506 connected to the system board 508, and a network interface 510 connected to the system board 508.

The processor 502 may include one or more single-core or multi-core processors. The processor 502 may include any combination of a general-purpose processor and a special-purpose processor (such as, a graphics processing unit, an application processor, or a baseband processor). In an embodiment of this invention, the processor 502 may be configured to perform one or more embodiments according to various embodiments shown in FIGS. 1-4.

In some embodiments, the system board 508 may include any suitable interface controller, to provide any suitable interface for at least one of the processors 502 and/or any suitable device or component communicating with the system board 508.

In some embodiments, the system board 508 may include one or more memory controllers to provide an interface connected to the system memory 504. The system memory 504 may be used to load and store data and/or an instruction. In some embodiments, the system memory 504 of the electronic device 500 may include any suitable volatile memory, such as a suitable dynamic random access memory (DRAM).

NVM 506 may include one or more tangible and non-transitory computer-readable media for storing data and/or the instruction. In some embodiments, NVM 506 may include any suitable nonvolatile memory such as a flash memory and/or any suitable nonvolatile storage device, such as a HDD (Hard Disk Drive, hard disk drive), a CD (Compact Disc, Compact Disc) drive, a DVD (Digital Versatile Disc, Digital Versatile Disc) drive.

NVM 506 may include a portion of storage resources installed on the apparatus of the electronic device 500, or may be accessed by a device, but is not necessarily part of a device. For example, NVM 506 may be accessed over a network via the network interface 510.

In particular, the system memory 504 and the NVM 506 may respectively include: a temporary copy and a permanent copy of the instruction 520. The instruction 520 may include: an instruction that causes the electronic device 500 to implement the method shown in FIGS. 1-4 when executed by at least one of the processors 502. In some embodiments, the instruction 520, hardware, firmware, and/or software components thereof may additionally/alternatively reside in the system board 508, the network interface 510, and/or the processor 502.

The network interface 510 may include a transceiver for providing a radio interface for the electronic device 500 to communicate with any other suitable devices (such as, a front-end module and an antenna) by using one or more networks. In some embodiments, the network interface 510 may be integrated with other components of the electronic device 500. For example, the network interface 510 may be integrated into at least one of the processor 502, the system memory 504, the NVM 506, and a firmware device (not shown) having an instruction, and when at least one of the processors 502 executes the instruction, the electronic device 500 implements one or more of the various embodiments shown in FIGS. 1-4.

The network interface 510 may further include any suitable hardware and/or firmware to provide a multiple-input multiple-output wireless interface. For example, the network interface 510 may be a network adapter, a wireless network adapter, a telephone modem, and/or a wireless modem.

In one embodiment, at least one of the processors 502 may be packaged with one or more controllers used for the system board 508 to form a system in a package (SiP). In one embodiment, at least one of the processors 502 may be integrated on the same die with one or more controllers used for the system board 508 to form a system on a chip (SoC).

The electronic device 500 may further include: an input/output (I/O) device 512 connected to the system board 508. The I/O device 512 may include a user interface, so that a user can interact with the electronic device 500; peripheral components can also interact with the electronic device 500 by using a design of a peripheral component interface. In some embodiments, the electronic device 500 further includes a sensor for determining at least one of environmental conditions and location information related to the electronic device 500.

In some embodiments, the I/O device 512 may include, but is not limited to, a display (such as, a liquid crystal display and a touch screen display), a speaker, a microphone, one or more cameras (such as, a still image camera and/or a video camera), a flashlight (such as, a LED flash), and a keyboard.

In some embodiments, the peripheral component interface may include, but is not limited to, a nonvolatile memory port, an audio jack, and a power interface.

In some embodiments, sensors may include, but are not limited to, gyroscope sensors, accelerometers, proximity sensors, ambient light sensors, and positioning units. The positioning unit may also be part of or interact with the network interface 510 to communicate with components of the positioning network, such as Global Positioning System (GPS) satellites.

It can be understood that, the structure illustrated in the embodiment of the present invention does not constitute a specific limitation on the electronic device 500. In other embodiments of the present application, the electronic device 500 may include more or fewer components than those shown in the figure, or combine some components, or split some components, or have different component arrangements. The illustrated components may be implemented in hardware, software, or a combination of software and hardware.

Program code can be applied to input instructions to perform the functions described in the present invention and to generate output information. The output information may be applied to one or more output devices in a known manner. For purposes of the present application, a system used for processing the instructions and including the processor 502 includes any system with a processor such as a digital signal processor (DSP), a microcontroller, an application specific integrated circuit (ASIC), or a microprocessor.

The program code can be implemented in a high-level programming language or an object-oriented programming language to communicate with a processing system. The program code can also be implemented in an assembly language or a machine language, if desired. In fact, the mechanism described in the present invention is not limited in scope to any particular programming language. In either case, the language may be an assembly language or an interpreted language.

One or more aspects of at least one embodiment may be implemented by instructions stored on a computer-readable storage medium that, when read and executed by a processor, enable an electronic device to implement the methods of the embodiments described in this invention.

According to some embodiments of this application, disclose a computer storage medium having stored thereon instructions which, when run on a computer, cause the computer executes a pathfinding method according to an embodiment of this application or a method for training a pathfinding graph neural network according to an embodiment of this application.

According to some embodiments of this application, disclose a computer program product including computer-executable instructions, which are executed by a processor to implement a pathfinding method according to an embodiment of this application or a method for training a pathfinding graph neural network according to an embodiment of this application.

It should be understood that the specific embodiments described herein are used merely to explain the present application, but are not intended to limit the present application. In addition, for ease of description, only some but not all structures or processes related to the present application are shown in the drawings. It should be noted that in this description, similar numerals and letters designate like items in the drawings.

It should be understood that although the terms first, second, etc. may be used in the present disclosure to describe various features, these features should not be limited to these terms. These terms are used for distinction only and shall not be understood as an indication or implication of relative importance. For example, without departing from the scope of example embodiments, a first feature may be referred to as a second feature, and similarly a second feature may be referred to as a first feature.

In the description of the present application, it is also to be noted that, unless expressly stated and defined otherwise, the terms “arrangement”, “connection”, “link” are to be understood in a broad sense, for example, as a fixed connection, as a detachable connection, or as an integrated connection; may be a mechanical connection or an electrical connection; may be directly connected or indirectly connected by means of an intermediate medium, and may be internal communication of the two elements. The specific meaning of the above terms in this embodiment will be understood by one of ordinary skill in the art.

Illustrative embodiments of the present application include, but are not limited to, a pathfinding method and a device, a pathfinding graph neural network training method and a device, a medium, and a computer program product.

Various aspects of the illustrative embodiments are described by using terms commonly used by persons skilled in the art to convey the substance of their work to others skilled in the art. However, it is apparent to the persons skilled in the art that some alternative embodiments may be practiced by using some of the described features. For purposes of explanation, specific numbers and configurations are set forth in order to provide a more thorough understanding of the illustrative embodiments. However, it is apparent to the persons skilled in the art that alternative embodiments may be practiced without the specific details. In other instances, well-known features have been omitted or simplified herein in order to avoid obscuring the illustrative embodiments of the application.

In addition, various operations will be described as a plurality of operations separated from each other in a manner most conducive to understanding the illustrative embodiments; however, the order of description should not be construed as to imply that these operations are necessarily dependent on the order of description, many of which operations may be performed in parallel, concurrently, or simultaneously. In addition, the order of operations can also be rearranged. When the described operations are completed, the processing may be terminated, but may further have additional steps not included in the figures. The processing may be corresponding to a method, a function, a procedure, a subroutine, a subprogram, or the like.

References in the specification to “an embodiment”, “embodiment”, “illustrative embodiment” and the like indicate that the described embodiments may include specific features, structures or properties, but each embodiment may or may not necessarily include specific features, structures or properties. Moreover, these phrases do not necessarily refer to the same embodiment.

Furthermore, when certain features are described with reference to specific embodiments, the knowledge of the persons skilled in the art can affect the combination of these features with other embodiments, whether or not those embodiments are explicitly described.

Unless the context otherwise requires, the terms “comprising,” “having,” and “including” are synonyms. The phrase “A and/or B” indicates “(A), (B) or (A and B)”.

As used herein, the term “module” may refer to, be a part of, or include: a memory (shared, dedicated, or group), an application-specific integrated circuit (ASIC), an electronic circuit, and/or a processor (shared, dedicated, or a group) that can execute one or more software or firmware programs, a combinatorial logic circuit, and/or another proper component that provides the function.

In the drawings, some structural or methodological features may be shown in a particular arrangement and/or order. However, it should be understood that no such specific arrangement and/or ordering is required. Rather, in some embodiments, features may be described in a different manner and/or order than shown in the illustrative figures. In addition, the inclusion of structural or methodological features in a particular figure does not imply that all embodiments need to include such features, and in some embodiments, these features may not be included or may be combined with other features.

In some cases, the disclosed embodiments may be implemented in hardware, firmware, software, or any combination thereof. The disclosed embodiments may also be implemented in the form of instructions or programs carried or stored on one or more transient or non-transient machine-readable (e.g., computer-readable) storage media, which may be read and executed by one or more processors or the like. When instructions or programs are run by a machine, the machine may perform the various methods described above. For example, the instructions may be distributed over a network or other computer-readable medium. Thus, a machine-readable medium may include, but is not limited to, any mechanism for storing or transmitting information in a form readable by a machine (e.g., a computer), such as a floppy disk, an optical disk, an optical disk read-only memory (CD-ROMs), a magneto-optical disk, a read-only memory (ROM), a random access memory (RAM), an erasable programmable read-only memory (EPROM), an electronically erasable programmable read-only memory (EEPROM), a magnetic or optical card, or a flash or tangible machine-readable memory for transmitting network information through electrical, optical, acoustic, or other forms of signals (e.g., a carrier wave, an infrared signal, a digital signal, etc.). Thus, a machine-readable medium includes any form of machine-readable medium suitable for storing or transmitting electronic instructions or machine (e.g., computer) readable information.

The embodiments of the present application have been described in detail above in connection with the drawings, but the use of the technical solutions of the present application is not limited to the various applications mentioned in the examples of the present patent, and various structures and variations can be readily implemented with reference to the technical solutions of the present application to achieve the various advantages mentioned herein. Various changes made without departing from the purpose of the present application shall fall within the scope of the patent of the present application, within the knowledge of one of ordinary skill in the art.

1. A pathfinding method for an electronic device, comprising:
acquiring a target map in a navigation grid format, and information of a starting grid and a target grid in the target map;
converting the target map into target graph data, wherein a first label is added to nodes corresponding to the starting grid and the target grid in the target graph data;
inputting the target graph data into a pre-trained pathfinding graph neural network, wherein the pathfinding graph neural network adds the first labels to some nodes of the target graph data and second labels to the remaining nodes; and
determining path grids in the target map, wherein the path grids are navigation grids of the target map which correspond to the nodes to which the first labels are added.

2. The method of claim 1, the pathfinding graph neural network is pre-trained through the following steps:
acquiring first sample graph data of a sample map and information of multiple sets of sample path grids in the sample map; adding first labels to the first sample nodes corresponding to the multiple sets of sample path grids in the first sample graph data, and adding second labels to the remaining first sample nodes, thereby obtaining second sample graph data;
training the graph neural network to be trained using the second sample graph data, so that the graph neural network to be trained learns the feature representation of the second sample graph data, and the influence probability distribution of the influence of the feature representation on the first labels or second labels;
M-step: using the influence probability distribution, adding the first labels or second labels to the first sample nodes in the first sample graph data, thereby obtaining third sample graph data, using part of the second sample nodes in the second sample graph data and part of the third sample nodes in the third sample graph data, training the graph neural network to be trained to learn the joint probability distribution of the nodes labeled with the first labels or second labels and the nodes not labeled with the first labels or second labels;
E-step: using the joint probability distribution, adding the first labels or second labels to the first sample nodes in the first sample graph data, thereby obtaining fourth sample graph data, using the fourth sample nodes in the fourth sample graph data and the second sample nodes in the second sample graph data, training the graph neural network to be trained to learn the influence probability distribution;
repeating the M-step and E-step until the prediction accuracy of the influence probability distribution and the joint probability distribution on the first labels and second labels of the second sample nodes in the second sample graph data exceeds a predetermined threshold, thereby obtaining the pathfinding graph neural network.

3. The method of claim 2, acquiring first sample graph data of a sample map and information of multiple sets of sample path grids in the sample map, comprising:
acquiring a sample map in a navigation grid format and information of multiple sets of sample starting grids and sample target grids in the sample map;
determining multiple sets of sample path grids using the A* algorithm based on the multiple sets of sample starting grids and sample target grids.

4. The method of claim 2, wherein the joint probability distribution is conditioned on the feature representation of the graph data.

5. The method of claim 1, further including:
the pathfinding graph neural network determining the feature representation of the target graph data, and the joint probability distribution of the nodes labeled with the first labels or second labels and the nodes not labeled with the first labels or second labels;
using GPU parallel computing to add the first labels or second labels to the nodes in the target graph data that have not been labeled, based on the feature representation of the target graph data and the joint probability distribution.

6. A method for training a pathfinding graph neural network for an electronic device, comprising:
acquiring first sample graph data of a sample map and information of multiple sets of sample path grids in the sample map; adding first labels to the first sample nodes corresponding to the multiple sets of sample path grids in the first sample graph data, and adding second labels to the remaining first sample nodes, thereby obtaining second sample graph data;
training the graph neural network to be trained using the second sample graph data, so that the graph neural network to be trained learns the feature representation of the second sample graph data, and the influence probability distribution of the influence of the feature representation on the first labels or second labels;
M-step: using the influence probability distribution, adding the first labels or second labels to the first sample nodes in the first sample graph data, thereby obtaining third sample graph data, using part of the second sample nodes in the second sample graph data and part of the third sample nodes in the third sample graph data, training the graph neural network to be trained to learn the joint probability distribution of the nodes labeled with the first labels or second labels and the nodes not labeled with the first labels or second labels;
E-step: using the joint probability distribution, adding the first labels or second labels to the first sample nodes in the first sample graph data, thereby obtaining fourth sample graph data, using the fourth sample nodes in the fourth sample graph data and the second sample nodes in the second sample graph data, training the graph neural network to be trained to learn the influence probability distribution;
repeating the M-step and E-step until the prediction accuracy of the influence probability distribution and the joint probability distribution on the first labels and second labels of the second sample nodes in the second sample graph data exceeds a predetermined threshold, thereby obtaining the pathfinding graph neural network.

7. The method of claim 6, acquiring first sample graph data of a sample map and information of multiple sets of sample path grids in the sample map, comprising:
acquiring a sample map in a navigation grid format and information of multiple sets of sample starting grids and sample target grids in the sample map;
determining multiple sets of sample path grids using the A* algorithm based on the multiple sets of sample starting grids and sample target grids.

8. The method of claim 6, wherein the joint probability distribution is conditioned on the feature representation of the graph data.

9. A electronic device, the device including a processor and a memory storing computer-executable instructions which, when executed by the processor, cause the electronic device to implement the method according to any one of claims 1-8.

10. A computer storage medium having stored thereon instructions which, when run on a computer, cause the computer to perform the method according to any one of claims 1-8.

11. A computer program product including computer-executable instructions executed by a processor to implement the method according to any one of claims 1-8.
